(19) United States
(12) Patent Application Publication
(10) Pub. No.: US 2018/0273659 A1
(43) Pub. Date: Sep. 27, 2018

(54) PROCESS FOR PREPARING POLYMER AND CARBON NANOSPHERES BY CATALYTIC POLYMERIZATION

(71) Applicant: Laurentian University of Sudbury, Sudbury (CA)

(72) Inventors: Zhibin Ye, Beaconsfield (CA); Vimal Kumar Tiwari, Seoul (KR); Zhe Chen, Sudburdy (CA)

(21) Appl. No.: 15/927,603

(22) Filed: Mar. 21, 2018

Related U.S. Application Data
(60) Provisional application No. 62/474,954, filed on Mar. 22, 2017.

(51) Int. Cl. C08F 38/02; C08F 8/50; C01B 32/154; C08F 2/18; C08F 2/22; C08F 2/44; B01J 21/06; B01J 23/42; B01J 23/44; B01J 23/72; B01J 23/745; B01J 23/75; B01J 23/755

(52) U.S. Cl. CPC C08F 38/02; B82Y 40/00; C01B 32/154; C08F 2/18; C08F 2/22; C08F 2/44; B01J 21/063; B01J 23/42; B01J 23/44; B01J 23/72; B01J 23/745; B01J 23/75; B01J 23/755; C08F 2500/24; C01P 2004/32; C08F 8/50

(57) ABSTRACT

The present disclosure relates to a process for preparing polymer and carbon nanospheres. In particular, the present disclosure is directed to preparing polymer nanospheres by catalytic emulsion or dispersion polymerization.

### CROSS REFERENCE TO RELATED APPLICATIONS

This application claims priority to and incorporates by reference U.S. Provisional Application Ser. No. 62/474,954 filed Mar. 22, 2017, entitled “PROCESS FOR PREPARING POLYMER AND CARBON NANOSPHERES BY CATALYTIC POLYMERIZATION,” the disclosure of which is expressly incorporated by reference herein in its entirety.

### FIELD

The present disclosure relates to a process for preparing polymer and carbon nanospheres. In particular, the present disclosure is directed to preparing polymer nanospheres by catalytic emulsion or dispersion polymerization.

### INTRODUCTION

Porous carbon nanospheres (CNSs) have recently received extensive attention for applications in energy storage (such as electrical double layer capacitors (EDLCs)), gas storage, organic vapor capture, and catalysis.₁ In general, porous CNSs are noted for greater pore accessibility and faster diffusions of ions/reactants, which are often the common performance parameters required in these applications. Because of the small sizes, CNSs tend to randomly aggregate, during their preparation, to conveniently form the desired 3-dimentional hierarchical pore structures that are featured with high pore volume and abundant inter-sphere macropores (>50 nm) and/or mesopores (2-50 nm) besides the intra-sphere micropores (<2 nm)._{1,2} Therein, intra-sphere micropores contribute predominantly to the energy or gas storage capacity,_{3,4} while the hierarchical 3-dimensionally interconnected macropores and mesopores can serve as buffer reservoirs of ions/molecules and facilitate their fast convenient transportation into the micropores._{1,2}

In general, CNSs with uniform diameters in the range of ca. 50-100 nm to micrometers have been extensively synthesized._{1,5-9} However, the synthesis of ultra-small CNSs with uniform, precisely tunable diameters below ca. 50 nm (i.e., 10-50 nm) has often been challenging, while such a ultra-small size range is particularly desired for the applications. In EDLC applications, the use of ultra-small CNSs has the advantage in offering short-range intrasphere micropores, and thus reduced diffusion paths for the ions/molecules in the micropores and better-maintained capacitance retention at high

Thus far, ultra-small CNSs with the size within 10-50 nm have only been synthesized in few reports as follows. In these few cases, the ultra-small size range (<50 nm) often represents the lowest end in the large targeted size windows and is thus not the primary focus of the syntheses. Meanwhile, the syntheses are often associated with various drawbacks or restrictions. In one case, hard-templated synthesis of mesoporous carbon nanoparticles with sizes as low as 10 nm were reported with mesoporous silicas as the template for carbon precursors._{5c,e} The synthesis is, however, complicated by the massive use of the silica templates and their tedious removal. Meanwhile, the ultra-small nanoparticles had rather poorly-defined nonspherical morphology._{5c} Zhao et al. reported the low-concentration synthesis of ordered mesoporous CNSs with uniform tunable sizes within 20-140 nm by the organic-organic self-assembly strategy.₆ₐ Therein, the low-concentration multi-step synthesis limits the practical large-scale production. Through a seeded Stöber synthetic strategy, Gan et al. synthesized CNSs with tunable sizes within 30-90 nm._{7g} But the process requires the inconvenient seed preparation and a very close monitoring of the growth of the seeds for the size control. Several reports_{8d-g} showed the synthesis of CNSs with sizes as low as ca. 20-50 nm by hydrothermal treatment of sugars in the presence of various additives followed with additional carbonization. CNSs obtained therein by the hydrothermal method often show nonuniform irregular nonspherical morphology, and have rather low surface area and porosity. In addition, Jang et al. synthesized ultra-small CNSs with the size of ca. 48 nm from polypyrrole nanospheres prepared by microemulsion polymerization._{9a-c} Those CNSs also have the drawback of low surface area and pore volume. Lastly, carbon quantumn dots with sizes typically below 10 nm or so have also been synthesized through various techniques.₁₂ But they are often restricted to fluorescence-related applications and are not within the scope of porous CNSs defined herein.

### SUMMARY

The present disclosure relates to a process for preparing polymer and carbon nanospheres. In particular, the present disclosure is directed to preparing polymer nanospheres by catalytic emulsion or dispersion polymerization which can be followed by pyrolysis for the preparation of carbon nanospheres.

Accordingly, in one embodiment of the present disclosure, there is included a process for preparing polymer nanospheres, the process comprising:
(a) forming an aqueous emulsion or dispersion with water and at least one compound having two or more alkyne moieties; and
(b) polymerizing the compound having two or more alkyne moieties in the emulsion or dispersion in the presence of a transition metal catalyst to form polymer nanospheres.

In one embodiment, the process further comprises subjecting the polymer nanospheres to pyrolysis to form carbon nanospheres.

In other embodiments, the polymer nanospheres are subjected to a hydrothermal treatment before pyrolysis.

In another embodiment, the polymer nanospheres are subjected to pyrolysis in the presence of a chemical activation agent (such as KOH, ZnCl2) alkali metal hydroxide or alkaline earth metal hydroxide.

In another embodiment, the polymer nanospheres are subjected to pyrolysis in the presence of a physical activation agent (such as CO2, air, etc.)

Other features and advantages of the present application will become apparent from the following detailed description. It should be understood, however, that the detailed description and the specific examples while indicating preferred embodiments of the application are given by way of illustration only, since various changes and modifications within the spirit and scope of the application will become apparent to those skilled in the art from this detailed description.

### BRIEF DESCRIPTION OF THE DRAWINGS

The present disclosure will now be described in greater detail with reference to the drawings in which:

FIG. 1 shows TEM images of polymerized nanospheres (PNS) and corresponding polymer (carbon) nanospheres (CNS) of the disclosure.

FIG. 2 shows (a) N₂ sorption curves for various PNS and CNS of the disclosure, and (b) mesopore/macropore size distribution curves.

FIG. 3 shows (a) TEM images of an activated CNS of the disclosure and (b) a CNS of the prior art.

FIG. 4 shows (a) CV curves at different voltage sweep rates for a CNS of the disclosure; (b) GCD curves at different current densities (1-10 A/g); (c) specific capacitance and capacitance retention as functions of current density; (d) Nyquist plot with inset showing the high frequency region; (e) Ragone plot; (f) cyclic stability at the current density of 5 A/g over.

FIG. 5 shows sorption isotherms for a CNS of the disclosure towards the vapor of toluene (a) and methanol (b).

FIG. 6 shows (a) CO₂/N₂ adsorption isotherms for a CNS of the disclosure, and (b) H₂ adsorption isotherms.

### DESCRIPTION OF VARIOUS EMBODIMENTS

### Definitions

The term “polymer nanosphere” as used herein refers to polymer-based spheres having diameters between less than about 1 nm to about 500 nm.

The term “carbon nanosphere” as used herein refers to polymer nanospheres which have been subjected to pyrolysis.

The term “aqueous emulsion” as used herein refers to a system containing a dispersion or droplets of the at least one compound having two or more alkyne moieties in which the compound/mixture is dispersed in the aqueous phase. Depending on the size of the droplets, the emulsion may be a “miniemulsion” where the droplets are between about 10-100 nanometers.

The term “aqueous dispersion” as used herein refers to a system in which the at least one compound having two or more alkyne moieties is distributed through the aqueous phase.

The term “compound having two or more alkyne moieties” as used herein refers to a compound possessing two alkyne (—C≡C—) moieties which are polymerizable in the presence of a catalyst to form polymer nanospheres.

The term “transition metal catalyst” as used herein refers to any transition metal catalyst and/or catalyst precursor as is introduced into the process and which is, if necessary, converted into the active phase, as well as active form, of the catalyst which catalyzes the polymerization of the at least one compound having two or more alkyne moieties.

The term “pyrolysis” as used herein refers to a process in which polymer nanospheres are converted to carbon nanospheres through the agency of heat.

The term “aryl” as used herein refers to cyclic groups that contain at least one aromatic ring, for example a single ring (e.g. phenyl) or multiple condensed rings (e.g. naphthyl). In an embodiment of the present disclosure, the aryl group contains 6, 9 or 10 atoms such as phenyl, naphthyl, indanyl, anthracenyl, 1,2-dihydronaphthyl, 1,2,3,4-tetrahydronaphthyl, fluorenyl, indanyl, indenyl and the like.

The term “heteroaryl” as used herein refers to aromatic cyclic or polycyclic ring systems having at least one heteroatom chosen from N, O and S and at least one aromatic ring. Examples of heteroaryl groups include, without limitation, furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl and quinazolinyl, among others.

The term “(C₁-Cₚ)-alkyl” as used herein means straight and/or branched chain, saturated alkyl radicals containing from one to “p” carbon atoms and includes (depending on the identity of p) methyl, ethyl, propyl, isopropyl, n-butyl, s-butyl, isobutyl, t-butyl, 2,2-dimethylbutyl, n-pentyl, 2-methylpentyl, 3-methylpentyl, 4-methylpentyl, n-hexyl and the like, where the variable p is an integer representing the largest number of carbon atoms in the alkyl radical.

The term “(C₂-Cₚ)-alkenyl” as used herein means straight and/or branched chain, unsaturated alkyl moieties containing from two to “p” carbon atoms and includes at least one carbon-carbon double bond and includes (depending on the identity of p) ethenyl, 1-propenyl, isopropenyl, 1-butenyl, 2-butenyl, t-butenyl, 1-pentenyl, 2-methyl-1-pentenyl, 3-methyl-1-pentyl, 4-methyl-1-pentyl, 1-hexenyl, 2-hexenyl and the like, where the variable p is an integer representing the largest number of carbon atoms in the alkenyl radical.

The term “surfactant,” as used herein refers to compounds having an amphiphilic structure which stabilize the dispersed phase of an emulsion. The term surfactant encompasses cationic surfactants, anionic surfactants, amphoteric surfactants, nonionic surfactants, zwitterionic surfactants, and mixtures thereof.

The term “hydrothermal” as used herein refers to an aqueous system under pressure and increased temperature.

### Process of the Disclosure

The present disclosure relates to a process for preparing polymer and carbon nanospheres. In particular, the present disclosure is directed to preparing polymer nanospheres by catalytic emulsion or dispersion polymerization and their subsequent pyrolysis to form carbon nanospheres having uniform sizes. In one embodiment, the nanosphere sizes are between about 1 nm to about 500 nm, or about 1 nm to about 50 nm, or about 10 nm to about 50 nm. In one embodiment, by changing the concentration of the monomers, the size and the size distribution of the carbon nanospheres are controlled. In one embodiment, the polymer or carbon nanospheres have narrow size distribution profiles between, for example, of about 11 nm, 26 nm, or about 38 nm.

Accordingly, in one embodiment, there is included a process for preparing polymer nanospheres, the process comprising:
(a) forming an aqueous emulsion or dispersion with water and at least one compound having two or more alkyne moieties; and
(b) polymerizing the compound having two or more alkyne moieties in the emulsion or dispersion in the presence of a transition metal catalyst to form polymer nanospheres.

In one embodiment, the process further comprises subjecting the polymer nanospheres to pyrolysis to form carbon nanospheres. In one embodiment, the pyrolysis of the polymer nanospheres results in the carbonization of the polymer nanospheres by dehydrogenation reactions to form the carbon nanospheres.

In another embodiment, the process involves the preparation of polymer or carbon nanospheres using one or more compounds with at least one compound containing two or more alkyne moieties.

In one embodiment, the compound having two or more alkyne moieties is a (C₁-C₂₀)-alkyl, (C₆-C₂₀)-aryl or (C₅-C₂₀)-heteroaryl compound, having two alkyne moieties. In one embodiment, the compound having two or more alkyne moieties is a (C₀-C₂₀)-alkyl, (C₆-C₂₀)-aryl or (C₅-C₂₀)-heteroaryl compound, having two terminal alkyne moieties. In one embodiment, the alkyne moieties have the formula —X—C≡C—H, in which X is (C₀-C₁₀)-alkylene, in which 1-3 carbon atoms are optionally replaced with O or N.

In another embodiment, the compound having two or more alkyne moieties has the structure

R-A-R

wherein,
A is optionally substituted (C₀-C₂₀)-alkyl, (C₆-C₂₀)-aryl or (C₅-C₂₀)-heteroaryl; each R is, independently or simultaneously, a moiety comprising an alkyne moiety; and wherein the optional substituents on A are one or more of halo, hydroxy, (C₁-C₆)-alkyl, (C₁-C₆)-alkoxy or (C₂-C₆)-alkenyl.

In another embodiment, the compound having two or more alkyne moieties has the structure

R-A-R

wherein,
A is optionally substituted (C₀-C₂₀)-alkyl, (C₆-C₂₀)-aryl or (C₅-C₂₀)-heteroaryl; each R is, independently or simultaneously, an alkyne moiety of the formula —X—C≡C—H; X is (C₀-C₂₀)-alkylene, in which 1-3 carbon atoms are optionally replaced with O or N; and
wherein the optional substituents on A are one or more of halo, hydroxy, (C₁-C₆)-alkyl, (C₁-C₆)-alkoxy or (C₂-C₆)-alkenyl.

In one embodiment, the compound having two or more alkyne moieties has the structure

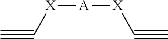

wherein
X is (C₀-C₂₀)-alkyl; and
A is optionally substituted (C₁-C₂₀)-alkyl, (C₆-C₂₀)-aryl or (C₅-C₂₀)-heteroaryl; and wherein the optional substituents on Ring A are one or more of halo, hydroxy, (C₁-C₆)-alkyl, (C₁-C₆)-alkoxy or (C₂-C₆)-alkenyl.

In one embodiment, A is (C₀-C₁₀)-alkyl. In one embodiment, A is (C₀-C₈)-alkyl, for example, 1,7-octadiyne, 1,6-heptadiyne, or 1,5-hexadiyne.

In one embodiment, A is (C₆-C₁₄)-aryl or (C₅-C₁₄)-heteroaryl. In another embodiment, A is (C₆-C₁₀)-aryl or (C₅-C₁₀)-heteroaryl. In another embodiment, A is substituted or unsubstituted phenyl or substituted or unsubstituted (C₅-C₆)-heteroaryl.

In one embodiment, X is (C₀-C₁₀)-alkyl, or (C₀-C₆)-alkyl, or (C₀-C₃)-alkyl.

In one embodiment, the optional substituents on A are one or more of halo, hydroxy, (C₁-C₃)-alkyl, (C₁-C₃)-alkoxy or (C₂-C₃)-alkenyl. In one embodiment, the optional substituents on A are one or more of fluoro, chloro, hydroxy, or (C₁-C₃)-alkyl.

In one embodiment, the compound having two or more alkyne moieties has the structure

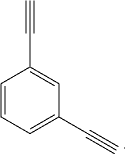

In another embodiment of the disclosure, the process further includes forming an aqueous emulsion or dispersion with water and at least one compound having two or more alkyne moieties, and a mono-alkyne compound.

In one embodiment, the mono-alkyne compound is a (C₀-C₂₀)-alkyl, (C₆-C₂₀)-aryl or (C₅-C₂₀)-heteroaryl compound, having one alkyne moiety. In one embodiment, the mono-alkyne compound is a (C₀-C₂₀)-alkyl, (C₆-C₂₀)-aryl or (C₅-C₂₀)-heteroaryl compound, having one terminal alkyne moiety. In one embodiment, the alkyne moiety has the formula —X′—C≡C—H, in which X′ is (C₀-C₁₀)-alkylene, in which 1-3 carbon atoms are optionally replaced with O or N.

In another embodiment, the mono-alkyne compound has the structure

R′-A′

wherein,
A′ is optionally substituted (C₀-C₂₀)-alkyl, (C₆-C₂₀)-aryl or (C₅-C₂₀)-heteroaryl;
R′ is a moiety comprising an alkyne moiety; and
wherein the optional substituents on A′ are one or more of halo, hydroxy, (C₁-C₆)-alkyl, (C₁-C₆)-alkoxy or (C₂-C₆)-alkenyl.

In another embodiment, the mono-alkyne compound has the structure

R′-A′

wherein,
A′ is optionally substituted (C₀-C₂₀)-alkyl, (C₆-C₂₀)-aryl or (C₅-C₂₀)-heteroaryl;
R′ is an alkyne moiety of the formula —X′—C≡C—H;
X′ is (C₀-C₂₀)-alkylene, in which 1-3 carbon atoms are optionally replaced with O or N; and
wherein the optional substituents on A′ are one or more of halo, hydroxy, (C₁-C₆)-alkyl, (C₁-C₆)-alkoxy or (C₂-C₆)-alkenyl.

In one embodiment, the mono-alkyne compound has the structure

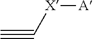

wherein
X′ is (C₀-C₂₀)-alkyl; and
A′ is optionally substituted (C₁-C₂₀)-alkyl, (C₆-C₂₀)-aryl or (C₅-C₂₀)-heteroaryl; and
wherein the optional substituents on A′ are one or more of halo, hydroxy, (C₁-C₆)-alkyl, (C₁-C₆)-alkoxy or (C₂-C₆)-alkenyl.

In one embodiment, A′ is (C₀-C₁₀)-alkyl. In one embodiment, A′ is (C₀-C₈)-alkyl, for example, 1-octyne, 1-heptyne, or 1hexyne.

In one embodiment, A′ is (C₆-C₁₄)-aryl or (C₅-C₁₄)-heteroaryl. In another embodiment, A′ is (C₆-C₁₀)-aryl or (C₅-C₁₀)-heteroaryl. In another embodiment, A′ is substituted or unsubstituted phenyl or substituted or unsubstituted (C₅-C₆)-heteroaryl.

In one embodiment, X′ is (C₀-C₁₀)-alkyl, or (C₀-C₆)-alkyl, or (C₀-C₃)-alkyl.

In one embodiment, the optional substituents on A′ are one or more of halo, hydroxy, (C₁-C₃)-alkyl, (C₁-C₃)-alkoxy or (C₂-C₃)-alkenyl. In one embodiment, the optional substituents on A′ are one or more of fluoro, chloro, hydroxy, or (C₁-C₃)-alkyl.

In one embodiment, the mono-alkyne compound has the structure

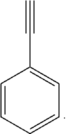

In one embodiment, when the process proceeds using an emulsion, surfactant-based emulsifiers are used, thereby forming micelles where the polymerization occurs resulting in polymer nanoparticles. In another embodiment of the disclosure, the emulsion further comprises a surfactant. In one embodiment, the surfactant is a cationic surfactant, anionic surfactant, amphoteric surfactant, nonionic surfactant, zwitterionic surfactant, and mixtures thereof. In one embodiment, the surfactant is an anionic surfactant. In one embodiment, the surfactant is sodium dodecyl sulfate. In another embodiment, the surfactant is hexadecyltrimethylammonium bromide, dodecyltrimethylammonium bromide, amphiphilic block copolymers like polystyrene-b-poly(ethylene oxide), etc. In another embodiment, the process also includes co-surfactants, such as alcohol or alkane, may also be added.

In another embodiment, when the process proceeds using a dispersion, stabilizers (and optionally, surfactants), are used, along with stirring or mixing to generate monomer droplets where polymerization proceeds to form polymer nanoparticles. In one embodiment, the stabilizer is a water-soluble polymer such as polyvinylalcohol, polyacrylic acid, or cellulose; or water-insoluble salts, such as MgCO3, CaCO3, etc. mixtures of any of the above.

In another embodiment of the disclosure, the transition metal catalyst comprises a transition metal which is iron, copper, cobalt, titanium, nickel, platinum, ruthenium, rhodium, palladium, tungsten, tantalum, or molybdenum. In one embodiment, the transition metal is palladium. In further embodiments, the metal catalyst comprises a ligand, such as phosphine ligands or aminophosphine ligands. In one embodiment, the active transition metal catalysts are prepared in situ, for example, by mixing Pd(OAc)2 and a ligand, such as α,α′-bis(di-t-butylphosphino)-o-xylene.

In another embodiment, the polymer nanospheres are heated to a temperature between about 500° C. to about 1000° C., or about 800° C. In some embodiments, the polymer nanospheres are converted to carbon nanospheres in amounts of at least about 60%, or at least about 70%, or at least about 80%.

In another embodiment, the polymer nanospheres are subjected to pyrolysis in the presence of an activator, such as alkali metal hydroxide or alkaline earth metal hydroxide. In one embodiment, the alkali metal hydroxide is potassium hydroxide. In another embodiment, the activator is a metal salt, such as zinc chloride, or a gas such as carbon dioxide or air. In some embodiment, during pyrolysis, the presence of an activator increases the pore structures in the carbon nanospheres, thereby increasing the pore surface area. In general, micropores with a size below about 2 nm is beneficial for electrochemical energy storage; mesopores (size between 2 and 50 nm) and macropores (size >50 nm) are important for fast diffusion. In some embodiments, high pore volume and surface area are desired for many applications. In some embodiments, the carbon nanospheres prepared herein possess hierarchical micro-meso-macropore structures due to their packing, which result in nanospheres having high capacity for supercapacitive energy storage and vapor/gas sorption meanwhile with fast kinetics performance.

In some embodiments, the nanospheres prepared by the process of the present disclosure have uniform diameter profiles between about 5 nm and 500 nm, or about 5 nm to about 100 nm, or about 10 nm to about 50 nm. In some embodiments, the polymer or carbon nanospheres have uniform size distributions of about 11nm, or about 21 nm, or about 38 nm. In further embodiments, the processes of the disclosure result in polymer or carbon nanospheres having narrow distribution profiles, for example, having PDI vales of less than about 0.10, or less than about 0.05, or about 0.05.

In one embodiment, before step (c) of the process, the polymer nanospheres are mixed with water and hydrothermally treated. In one embodiment, the polymer nanospheres are heated to a temperature of between about 100° C. to about 300° C., or about 220° C.

In some embodiments, the size distribution profile of the nanospheres is controlled by the concentration of the compound having two or more alkyne moieties. In one embodiment, the higher the concentration of the compound results in a higher size distribution profile, while lower concentrations result in lower size distribution profiles. For example, polymer nanospheres having size distribution profiles of about 11 nm, 21 nm or 38 nm, can be synthesized using concentrations of about 0.024, 0.051 or 0.48 g/ml, respectively.

In some embodiments, the activated carbon nanospheres prepared by the present disclosure have surface areas of at least about 1000 m²/g, or at least about 1500 m²/g, or at least about 2000 m²/g, or at least about 2300 m²/g.

In some embodiments of the disclosure, the process yields polymer nanospheres in greater than about 90%, or greater than about 95%, or greater than about 99%, or about 100%, monomer conversion such that there are little or no by-products.

### Nanospheres

The present disclosure also includes polymer or carbon nanospheres. In one embodiment, the polymer nanospheres comprise:
a) nanospheres comprising a cross-linked polymer, wherein the cross-linked polymer is comprised of monomers having two or more alkyne moieties, wherein the cross-linked polymer further comprises pendant alkyne moieties.

In another embodiment, the polymer nanospheres of the present disclosure have PDI vales of less than about 0.10, or less than about 0.05, or about 0.05.

In another embodiment, the present disclosure also includes carbon nanospheres, comprising
a) nanospheres comprising a cross-linked polymer, wherein the cross-linked polymer is comprised of monomers having two or more alkyne moieties,
wherein the cross-linked polymer further comprises pendant alkyne moieties, and
wherein the cross-linked polymer has been carbonized.

In one embodiment, the carbon content in the carbon nanospheres is at least about 75%, or at least about 80%, or at least about 90%.

In some embodiments, the activated carbon nanospheres of the present disclosure have surface areas of at least about 1000 m²/g, or at least about 1500 m²/g, or at least about 2000 m²/g, or at least about 2300 m²/g. In some embodiments, the carbon nanospheres are sorbents for gases, such as CO₂ or H₂, and vapors such as organic compounds, such as toluene or methanol.

The monomers having two or more alkyne moieties are the same as the compounds having two or more alkyne moieties as describe above in the process of the disclosure.

In a further embodiment, the polymer nanospheres and the carbon nanospheres are further comprised of monomers having one alkyne moiety. The monomer having one alkyne moiety is as defined above in the process of the disclosure.

In further embodiments, the polymer or carbon nanospheres are useful as adsorbents for absorbing materials or compounds which come into contact with the nanospheres. In other embodiments, the nanospheres are useful as electrode materials for electrochemical supercapacitors and batteries. In another embodiment, the nanospheres are useful as catalyst supports.

Although the disclosure has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present disclosure.

### EXAMPLES

The operation of the disclosure is illustrated by the following representative examples. As is apparent to those skilled in the art, many of the details of the examples may be changed while still practicing the disclosure described herein.

### Materials

1,3-Diethynylbenzene (DEB, 97%, Aldrich), palladium acetate (Pd(OAc)₂, 98%, Strem Chemicals), α,α′-bis(di-t-butylphosphino)-o-xylene (97%, Strem Chemicals), methanesulfonic acid (99.5%, Aldrich), dichloromethane (HPLC grade, Fisher Scientific), methanol (ACS reagent, Fisher Scientific), sodium dodecyl sulphate (SDS, ≥99%, Aldrich), sulfuric acid (96%, Aldrich), titanium foil (99.95%, Aldrich), and conducting carbon (acetylene black 100%, Soltex) were all used as received. Deionized water was obtained from a Barnstead/Synbron Nanopure II water purification system.

### Example 1

### Synthesis of Polymer Nanospheres (PNSs) by Catalytic Emulsion Polymerization

The following is the typical procedure for the synthesis of PNSs with the average diameter of ˜21 nm. DEB (1.86 g, 14.7 mmol) was added into a flask containing an aqueous solution of SDS (0.8 g in 15.6 mL). The mixture was sonicated for 10 min and then stirred with a magnetic stirrer at 400 rpm for 5 h at 60° C. A Pd catalyst solution was prepared by dissolving Pd(OAc)₂ (3.31 mg, 14.7 μmol) and α,α′-bis(di-t-butylphosphino)-o-xylene (17.45 mg, 44 μmol) in a mixture of dichloromethane (0.18 mL) and methanol (0.02 mL). The catalyst solution was injected into the monomer emulsion, followed with the addition of two drops of methanesulfonic acid, to start the emulsion polymerization. The polymerization lasted overnight with a maintained stirring speed of 400 rpm at 60° C., rendering an intense dark brown emulsion dispersion. As per dynamic light scattering (DLS) analysis of the diluted dispersions, the resulting PNSs have the average size of 21 nm.

For the synthesis of PNSs with average diameter of 11 nm, DEB (0.93 g, 7.37 mmol) was added into an aqueous solution of SDS (1.0 g in 39 mL). The mixture was sonicated and then stirred at 60° C. A catalyst solution, containing Pd(OAc)₂ (16.55 mg, 73.7 μmol) and α,α′-bis(di-tbutylphosphino)-o-xylene (87.25 mg, 221 μmol) in 0.9 mL of dichloromethane and 0.1 mL of methanol, was injected into the monomer emulsion, followed with the addition of four drops of methanesulfonic acid, to start the polymerization. The emulsion polymerization lasted overnight under stirring at 400 rpm at 60° C. DLS analysis of the diluted emulsion showed that the resulting PNSs have the average size of 11 nm.

For the synthesis of PNSs with average diameter of 38 nm, DEB (1.86 g, 14.7 mmol) was added into an aqueous solution of SDS (0.1 g in 3.9 mL of water) in a flask, followed with sonication and mechanical stirring at 60° C. A catalyst solution, containing Pd(OAc)₂ (3.3 mg, 15 μmol) and α,α′-bis(di-t-butylphosphino)-o-xylene (17.4 mg, 44 μmol) in 0.18 mL of dichloromethane and 0.02 mL of methane, was injected into the monomer emulsion, along with the addition of one drop of methanesulfonic acid. The polymerization lasted overnight at 60° C. under the maintained stirring at 400 rpm, rendering the emulsion product.

### Example 2

### Synthesis of Carbon Nanospheres by Carbonization of Polymer Nanospheres Without or With Activation

The PNS emulsions prepared above were first hydrothermally treated, after dilution with water, at ca. 220° C. for overnight in a Teflon-lined autoclave. The resulting polymer precipitates were collected by filtration, washed with an excessive amount of water, and then dried at 60° C. under vacuum for 24 h, rendering the hydrothermally treated PNSs (PNS11, PNS21, and PNS38). Direct carbonization of the hydrothermally treated PNSs without activation was performed by their pyrolysis at 800° C. for 1 h (preceded with heating at 10° C./min from 25 to 800° C.) in a nitrogen atmosphere in a tube furnace, rendering the non-activated CNSs (CNS11, CNS21, and CNS38, respectively).

For the preparation of KOH-activated carbon nanospheres (A-CNS21), PNS21 and KOH (at 1:3 mass ratio) were mixed in methanol, followed with the evaporation of methanol under vacuum. Carbonization was then performed using the same procedure above in a nitrogen atmosphere. To removal residual KOH, the carbonization product was sequentially washed with a large amount of aqueous 2% HCl solution, deionized water, and methanol. It was then dried overnight at 60° C. under vacuum, rendering the chemically activated carbon nanospheres, A-CNS21.

### Characterization and Measurements

DLS measurements of the diluted emulsions (concentration at ca. 0.2 mg/mL) for sizing of the polymer nanospheres were performed on a Malvern Zeta-Sizer Nano S90 instrument at 30° C. Transmission electron microscopy (TEM) images of the various polymer and carbon nanospheres were captured on a Philips EM400 transmission electron microscope operated at 100 keV. TEM samples were prepared by depositing a few drops of the sonciated dilute dispersion of polymer/carbon nanosphere samples in acetone (ca. 0.1 mg/mL) on lacey grids (EMS Supplies), followed with drying. For each sample, about 100 nanospheres were randomly picked and analyzed to determine the average nanosphere size and size distribution. Scanning electron microscopy (SEM) images were taken with a JEOL JSM-7401F field-emission scanning electron microscope. The samples were prepared by depositing a few drops of dilute dispersions on a small piece of conductive silicon wafer followed with drying at ambient temperature, which was then mounted to a SEM specimen stub. X-ray diffraction (XRD) patterns of the carbon samples were recorded on an X′Pert Pro diffractometer with Co radiation (wavelength 1.79 Å) at room temperature. X-ray photoelectron spectroscopy (XPS) measurements of the carbon samples were carried out on a Thermo Scientific Theta Probe XPS spectrometer. A monochromatic Al K [symbol] x-ray source was used, with a spot area of 400 μm.

N₂ sorption measurements of the various samples at 77 K were carried out on a Micromeritics ASAP2020 physiosorption analyzer to determine Brunauer-Emmert-Teller (BET) specific surface area, pore volume, and pore size distribution. Before the measurements, the samples were degassed for at least 24 h at 100 and 300° C. for the polymer and carbon samples, respectively. The micropore size distribution was calculated from the N₂ sorption data within the relative pressure (P/P₀) range of 0-0.01 with the use of both the non-local density functional theory (NLDFT) model. The pore size distribution for pores greater than 20 Å (i.e., mesopores and macropores) was calculated from N₂ desorption data (P/P₀=ca. 0.4-0.99) using the NLDFT model. The sorption isotherms of CO₂ and H₂ with the CNS samples were measured with the same instrument at 0 and −196° C., respectively. Prior to the measurements, the carbon samples were degassed under vacuum at 300° C. for ca. 20 h.

The vapor sorption isotherms of toluene and methanol were obtained using a Belsorp-max instrument (MicrotracBel Corp.) at 25° C. Prior to the adsorption measurement, the adsorbents (30-50 mg) were degassed under vacuum at 300° C. for ca. 20 h. The isotherms were measured from ca. 0.01 kPa up to the saturation vapor pressure of the adsorbate at 25° C.

### Example 3

### EDLC Supercapacitor Electrode Fabrication and Electrochemical Measurement

All electrochemical measurements of the EDLC supercapacitors, including cyclic voltammetry (CV), galvanostatic charge/discharge (GCD), and electrochemical impedance spectroscopy (EIS), were conducted on a Metrohm Autolab PGSTAT 100 potentiostat/galvanostat in the 2-electrode configuration with aqueous 1 M H₂SO₄ solution as the electrolyte. The electrodes were fabricated with the various carbon samples on a titanium foil (4 cm₂) as the current collector. To prepare electrodes, the active carbon sample (80 wt %), conducting carbon (10 wt %), and Nafion (10 wt %) were dispersed in ethanol under sonciation in a small vial. The dispersion was then evenly coated onto the titanium current collector (active material density of 1.1 mg/cm₂). Subsequently, the electrodes were dried in an oven. Symmetrical two-electrode cells were prepared by sandwiching a piece of filtration paper between the two electrodes and were filled with the electrolyte solution. CV measurements were performed in the voltage range of 0-1 V at the voltage sweep rate of 200, 50, 25, 10, 5, 1 mV/s, respectively. The specific capacitance (Cₛₚ in F/g) was calculated from the CV curves through the following equation:

$${C}_{sp} = \frac{\int idV}{m Δ Vu} \qquad ( 1 )$$

where i and V are the current and voltage, respectively, in the CV curves, m is the mass of the active carbon in one single electrode, and v is the voltage sweep rate. GCD measurements were performed within voltage range of 0-1 V at current densities of 50, 30, 20, 10, 5, 3, 2, 1, 0.5, 0.25, and 0.1 A/g, respectively. Cₛₚ was also calculated from the discharge curve through the following equation:

$${C}_{sp} = \frac{2 i}{mdV \text{/} dt} \qquad ( 2 )$$

where i is the discharge current, m is carbon mass in each electrode, and dV/dt is calculated as the slope of the discharge curve within the voltage range following the end of ohmic drop to the end of the discharge curve. The energy density (E, in Wh/kg) and power density (P, W/kg) were calculated according to:

$$\begin{matrix}E = \frac{1}{2} {C}_{sp} {V}^{2} \cdot \frac{1}{4} \cdot \frac{1}{3.6} & ( 3 ) \\ P = \frac{E}{t} & ( 4 )\end{matrix}$$

where V is the cell voltage after ohmic drop and t is the discharge time (in h). The EIS measurement was also conducted at static potential of 0 V over the frequency range from 10 kHz to 0.01 Hz with an AC perturbation of 10 mV.

### Results and Discussion

The synthesis of CNSs herein involves the following steps: (1) catalytic emulsion polymerization and hydrothermal treatment of resulting polymer nanospheres and carbonization of the polymer nanospheres. Scheme 1 illustrates schematically the synthetic procedure. In one embodiment, DEB, a difunctional cross linkable alkyne monomer (molecular formula Cal-le) featured with a high carbon content (95 wt %), is employed as the monomer precursor for the catalytic emulsion polymerization. It has been shown that Pd-catalyzed coordinative addition polymerization of DEB can efficiently yield highly cross-linked polymers, which can subsequently give rise to porous carbons with particle sizes in the micrometer range at high yield (83%) by pyrolysis.₁₃ Featured predominantly with micropores, the resulting porous activated carbons show electrochemical capacitance values at low current densities though with relatively limited capacitance retention at high current densities.₁₃

In the method, emulsion polymerization of DEB was undertaken with the use of an in situ generated cationic diphosphine-ligated Pd catalyst, Pd(OAc)₂/ [symbol] , [symbol] -bis(di-tertbutylphosphino)-o-xylene/methanesulfonic acid.₁₄ SDS is used as the surfactant with its concentration in the range of 0.025-0.05 g/mL, which is far greater than its critical micelle concentration of ca. 0.0029 g/mL so as to achieve miniemulsions.₁₆ a change in SDS concentration in the above range shows no pronounced effects on the size of the resulting PNSs. Instead, the feed concentration of DEB monomer in water has the predominant effect on the size of the PNSs. Efficient tuning of the size of PNSs can be conveniently achieved by simply changing the DEB feed concentration in water. As a demonstration, a range of PNSs having three different average sizes (PNS11, PNS21, PNS38 with the average size of 11, 21, and 38 nm, respectively determined by DLS and/or TEM characterizations) were synthesized at different DEB concentrations, 0.024, 0.051, and 0.48 g/mL, respectively. Particle size analysis of the three as-produced PNS miniemulsions by both DLS and TEM confirms their average sizes and the very narrow size distribution (polydispersity index as low as 0.02 and 0.08 for PNS11 and PNS21, respectively, as per DLS; see Figure S1 in Supporting Information).

The resulting emulsions containing PNSs were subsequently treated hydrothermally at ca. 220° C. In one embodiment, an optional hydrothermal treatment renders the resulting CNSs with better retained nanosphere morphology during the subsequent carbonization, which, without being bound by theory, is reasoned to result from further enhanced cross-linking density within the PNSs by continued polymerization reactions at the elevated temperature during the hydrothermal treatment. Meanwhile, the treatment also decomposes/destabilizes SDS and facilitates its easy removal through simple washing, which is otherwise difficult to remove from the as-produced miniemulsions even by extensive washing. From the weights of hydrothermally treated PNSs, DEB conversion during the emulsion polymerizations was found to be nearly quantitative (over 90% in all cases), indicating high efficiency of the catalytic polymerization. The hydrothermally treated PNSs were then carbonized at 800° C. for 1 h under the N₂ atmosphere in the absence of any activation agent to render the CNSs (CNS11, CNS21, and CNS38, respectively, with the number representing the average size of the CNSs). Relative to the PNS precursors, the yield of CNSs is about 80 wt %.

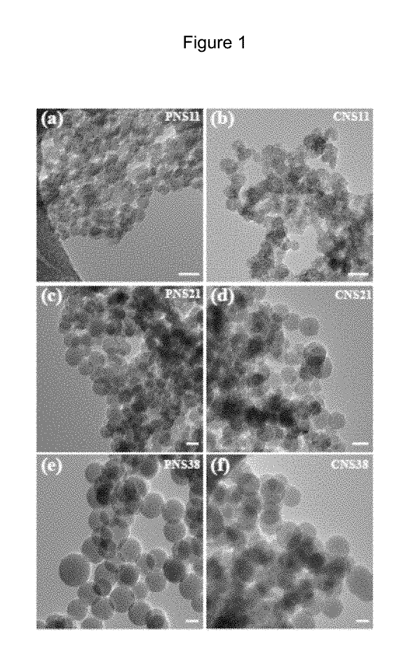

FIG. 1 shows TEM images of the hydrothermally treated PNSs and their resulting CNSs. All the PNS and CNS samples are composed of aggregates/compacts of well-defined nanospheres of very uniform sizes. In the case of PNS11 and CNS11, aggregation of the nanospheres is more severe compared to the others due to their smallest nanosphere sizes, with fused nanospheres observed in CNS11. By analyzing more than 100 nanospheres from the TEM images of each sample, the average size of the PNS samples agrees well with those determined by DLS analysis of the as-produced emulsions, indicating that the hydrothermal treatment has no pronounced effect on the size of the polymer nanospheres. Meanwhile, the resulting CNSs also have nearly identical average nanosphere size as the corresponding PNS precursors with no obvious deterioration in the nanosphere morphology during the carbonization. The TEM images show the successful synthesis of the CNSs of well-defined easily tunable ultra-small sizes in the desired range of 11-38 nm by this catalytic emulsion polymerization strategy,

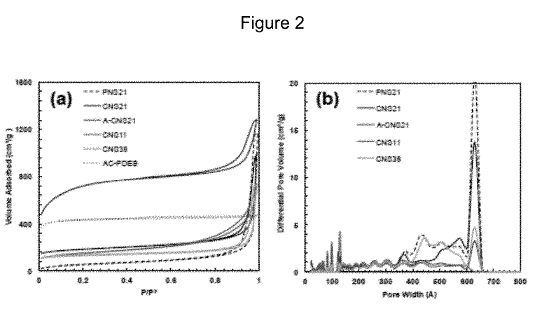

N₂ sorption characterization of the CNS samples (CNS11, CNS21, and CNS38), as well as PNS21 as a representative PNS sample, was undertaken at 77 K. FIG. 2(a) shows the N₂ sorption isotherms of the samples, with the results summarized in Table 1. Generally, the samples (CNS samples and PNS21) all show typical type IV isotherms,₁₇ with a slight uptake in the low relative pressure range (P/P₀<0.1), a sharp uptake at the high relative pressure end (0.8<P/P₀<1), and the presence of a distinct hysteresis loop in the P/Po range of 0.8-1. Except CNS11 that shows a hysteresis loop intermediate between types H1 and H3, PNS21, CNS21, and CNS38 all show a type H1 hysteresis loop,17 with the two branches being almost vertical and parallel over an appreciable range of N₂ uptake. The type H1 hysteresis is often associated with agglomerates/compacts of approximately uniform spheres in fairly regular array.₁₇ This also confirms the uniform nanospheres present in these samples (PNS21, CNS21, and CNS38) and indicates their relatively regular packing to form narrow-distributed inter-nanosphere pores. On the contrary, the type H3 hysteresis loop is often observed in aggregates of plate-like particles that give rise to slit-shaped pores.₁₇ The intermediate hysteresis loop in CNS11 is indicative of the presence of some plate-like particles formed by fusion of nanospheres during carbonization, which is in agreement with the finding from its TEM image (FIG. 1(b)).

The polymer nanospheres in PNS21 appear to be solid with negligible intra-sphere micropores given the marginal N₂ uptake at the low relative pressure range. It has a low BET surface area of 199 m₂/g, with negligible micropore surface area, and a high total pore volume of 1.80 cm₃/g arising exclusively from the inter-sphere mesopores/macropores generated by the packing of nanospheres. The carbon nanospheres in the CNS samples (CNS11, CNS21, and CNS38) have a total BET surface area of 493, 580, and 407 m₂/g, respectively, and a total pore volume of 1.04, 1.52, and 1.13 cm₃/g, respectively (see Table 1). They have significant intra-sphere micropores, with the micropore surface area contributing about 60% of surface area in CNS21 and CNS38, and 33% in CNS11. But the majority (90%) of pore volume arises from inter-sphere mesopores/macropores. FIG. 2(b) compares the mesopore/macropore size distribution of the samples obtained with the NLDFT model. PNS21, CNS21, and CNS38 have the pore size distribution primarily in the narrow range of 40-66 nm, with similar average mesopore/macropore sizes (44.3, 41.6, and 40.7 nm, respectively). In particular, CNS21 has a similar distribution pattern as its precursor PNS21 and both have the peak distribution intensity at 63 nm. Instead, CNS11 show a broader distribution within 2-60 nm, with the peak distribution intensity at around 12 nm and a lowered average mesopore/macropore size of 26.1 nm.

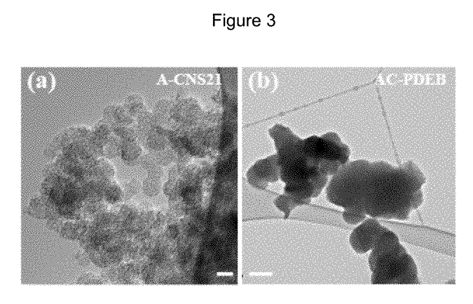

To obtain carbon nanospheres with higher surface area for applications as high-capacitance supercapacitor electrode materials or high-capacity sorbents, KOH-activated carbon nanospheres were prepared (A-CNS21) by carbonizing PNS21 in the presence of KOH (at a KOH/PNS21 mass ratio of 3/1) as the chemical activation agent under N₂ at 800° C. for 1 h. FIG. 3 shows a TEM image of A-CNS21. Though some fused spheres are present, the nanosphere morphology is still clearly observable in the TEM image. Its N₂ sorption isotherm is also included in FIG. 2(a). A strong uptake is seen in the low relative pressure range, indicative of the significant presence of micropores, along with an hysteresis loop intermediate between types H1 and H3 within the relative pressure range of 0.7-1. It has a high BET surface area of 2,360 m²/g and a high total pore volume of 1.98 cm₃/g, which are dramatically enhanced relative to the unactivated CNS21. Meanwhile, it also has significant micropore size surface area (882 m₂/g; 37% of total surface area) and micropore volume (0.46 cm₃/g; 23% of total pore volume). The use of KOH as an activation agent generates intra-sphere micropores and mesopores. Compared to CNS21, its average mesopore/macropore size is reduced to 26.8 nm, due to the creation of small intra-sphere mesopores and narrowing of some of the inter-sphere mesopores/macropores due to nanosphere fusion. Nevertheless, like CNS21, A-CNS21 shows the peak distribution intensity at 63 nm in the mesopore/macropore size distribution curve (see FIG. 2(b)), confirming the retention of nanosphere morphology despite the involvement of chemical activation.

For the purpose of comparison, an activated carbon control sample, AC-PDEB, was also syntheiszed from the non-nanostructured cross-linked polymer of DEB (PDEB) as the polymer precursor of the same chemical composition as PNS21. Unlike PNS21, PDEB, synthesized by conventional catalytic polymerization in organic media, does not contain nanoscale structures. Under TEM, it has irregular large sizes (ca. 1-10 μm).₁₃ AC-PDEB was obtained by carbonization of PDEB in the presence of KOH at identical conditions as for ACNS21. FIG. 3(b) shows a TEM image of AC-PDEB, where irregular particles with dimensions in the range of around 0.2 μm to a few microns can be seen. AC-PDEB shows a type I isotherm with a negligibly small hysteresis loop (see FIG. 2(a)) and is thus predominantly microporous with marginal meso-/macropore structures. This marks its distinct difference from A-CNS21 of hierarchical micro-/meso-/macropore structures synthesized from nanostructured PNSs. AC-PDEB has a BET surface area of 1,308 m₂/g and a total pore volume of 0.73 cm₃/g, with the majority (83 and 78%, respectively; see Table 1) arising from micropores. As per micropore analysis via the NLDFT model, A-CNS21 has a slightly higher average micropore size (9.1 vs. 8.0 nm) than AC-PDEB.

Both A-CNS21 and AC-PDEB were characterized with XPS for their chemical composition and chemical identity. The atomic composition survey reveals that A-CNS21 contains C at ca. 92 atom % and O at 7 atom % while AC-PDEB has the corresponding contents of 95 and 4 atom %, respectively. The slightly higher O content in ACNS21 than in AC-PDEB is reasoned to arise from the inter-sphere mesopores/macropores present in PNS21, which facilitate deeper and more uniform penetration of KOH for enhanced chemical activation

### Electrochemical Supercapacitive Performances

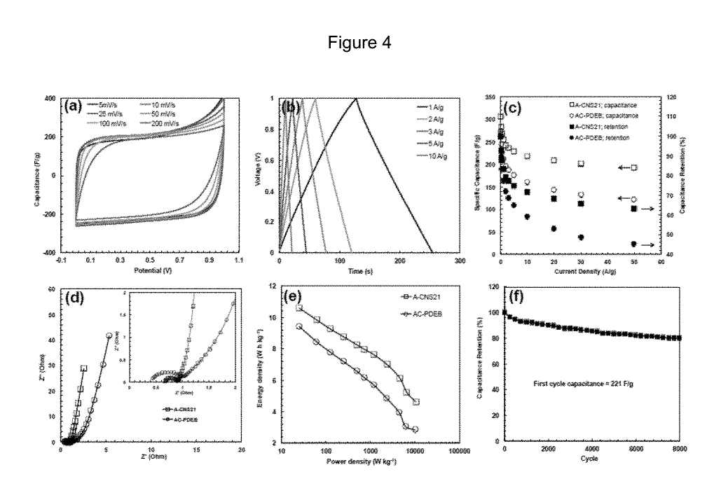

A-CNS21 has been thoroughly evaluated herein for its electrochemical supercapacitive performances in a two-electrode symmetrical cell in 1 M H₂SO₄ aqueous electrolyte. CV, GCD, and EIS measurements were undertaken, with the results summarized in FIGS. 4. The CV curves shown in FIG. 4(a) exhibit the typical rectangular shapes even at the high voltage sweep rate of 200 mV/s, along with only small reductions in the area of the rectangles with the gradual increase of voltage sweep rate from 5 to 200 mV/s. These are indicative of the ideal capacitive behavior and the capacitance retention at the high sweep rates. The specific capacitance calculated from the CV curves decreases only slightly from 214 F/g at 5 mV/s to 167 F/g at 200 mV/s, representing 78% of capacitance retention at 200 mV/s. In contrast, the CV curves of AC-PDEB show increasingly obvious distortions from the rectangular shape with the increasing sweep rates, along with the pronounced decrease in the enclosed area. Its specific capacitance calculated from the CV curves shows a severe drop from 187 F/g at 5 mV/s to 101 F/g at 200 mV/s, representing only 54% of retention.

The GCD curves of A-CNS21 (see FIGS. 4(b)) also exhibit the typical triangular shapes found with ideal capacitors. The voltage drops in the discharge curves resulting from equivalent series resistance are favorably small (e.g., only 0.068 V at 10 A/g). FIG. 4(c) plots the specific capacitance and capacitance retention obtained from the GCD measurements at different current densities. A high specific capacitance of 305 F/g is obtained at 0.1 A/g, with only slight decreases to 255 and 219 F/g at 1 and 10 A/g, respectively. On the contrary, the specific capacitance values of AC-PDEB are 273, 211, and 160 F/g at the three corresponding current densities. Meanwhile, the percentages of capacitance retention of A-CNS21 at the various high current densities far exceed those of AC-PDEB. For example, in reference to the specific capacitance at 0.1 A/g, 72% of capacitance retention is achieved with A-CNS21 at 10 A/g while the corresponding retention is 58% for AC-PDEB. The high specific capacitance and capacitance retention values achieved herein with A-CNS21 exceed or compare well to those of many other high-performance porous carbons.

FIG. 4(d) compares the Nyquist plots of A-CNS21 and AC-PDEB, obtained from EIS measurements within the frequency range of 10 kHz to 0.01 Hz. Both carbons show a distinct semicircle at high frequency and a nearly vertical line at low frequency. In the plot of AC-PDEB, an additional long inclined Warburg-type line (with slope at about 45°; see inset in FIG. 4(d)) at intermediate frequency is present while it is nearly absent in the plot of A-CNS21. It is known that the semicircle corresponding to the faradic charge-transfer resistance arises primarily from the ion transport within the mesopores and the Warburg-type line is ascribed to the ion movement within micropores._{19b} Herein, the semicircle of A-CNS21 is much smaller (0.227Ω) than that (0.553Ω) of AC-PDEB (see the inset in FIG. 4(d)), indicating the significantly lowered ion transport resistance within mesopores in A-CNS21 due to the presence of the abundant mesopore volume within the hierarchical structures. Meanwhile, the absence of the Warburg line in A-CNS21 also confirms the dramatically reduced ion transfer resistance within its intra-sphere micropores due to their shortened diffusion length as a result of the ultra-small nanosphere size and/or the presence of intra-sphere mesopores. The intrinsic ohmic resistance (the first intercept of the semicircle along the real axis) of A-CNS21 is slightly higher than that of AC-PDEB (0.67 vs. 0.44Ω), indicating the slightly lower conductivity in A-CNS21 due to the higher porosity. But the equivalent series resistance (ESR), obtained by extrapolating the vertical portion in the low-frequency region, is significantly lower in A-CNS21 than in AC-PDEB (1.16 vs. 2.54Ω). The difference of 1.38Ω in the two ESR values should result from the smaller charge transfer resistance and, more importantly, the faster ion diffusion within shorter micropores in A-CNS21.

The Ragone plot (see FIG. 4(e)) shows that a high energy density of 10.6 Wh/kg is achieved with A-CNS21, which is much higher than the common carbon electrode of about 5 Wh/kg.₆ᵢ A cyclic stability test was preformed on a two-electrode cell fabricated with A-CNS21 for 8,000 GCD cycles at 5 A/g. FIG. 4(f) plots the capacitance retention curve. About 80% of the initial capacitance (221 F/g) is retained after 8,000 cycles, confirming its cyclic stability.

### Organic Vapor Sorption Performances

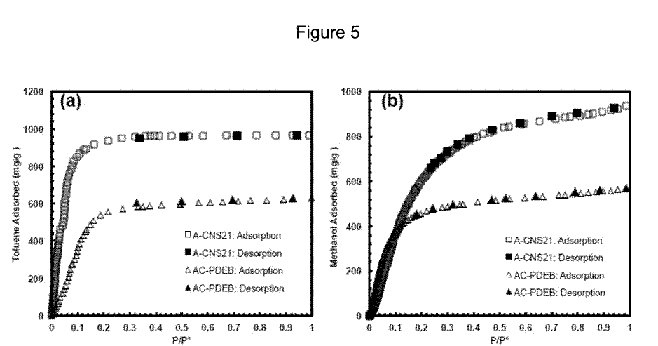

With its high surface area and pore volume, A-CNS21 of hierarchical pore structures is also attractive for adsorption of VOCs that are of serious environmental concern. Herein, its adsorption properties towards the vapor of two representative VOCs, toluene and methanol, have been investigated, along with AC-PDEB for comparison. FIG. 5 shows the adsorption isotherms measured at 25° C., with the adsorption capacity at different relative vapor pressures (P/P₀) summarized in Table 2. From the figure, both A-CNS21 and AC-PDEB exhibit type I isotherms for the adsorption of both toluene and methanol. A-CNS21 shows the maximum adsorption capacities of 967 and 937 mg/g for toluene and methanol, respectively, at P/P₀ of 0.99. These maximum capacity data are very high and are well comparable to those of many other porous materials studied for organic vapor adsorption, such as porous carbons (456-1,500 mg/g and 243-1,230 mg/g for toluene and methanol, respectively), microporous polymers (780-1,357 mg/g and 289-934 mg/g for toluene and methanol, respectively), and metal organic framework (MOF, 125-1,285 mg/g and 100-480 mg/g for toluene and methanol, respectively).₆ᵢ

Most distinctively, A-CNS21 shows extremely high adsorption capacity for both toluene and methanol specially within the low P/P₀ range (P/P₀<0.1), with very steep isotherms. At P/P₀ of 0.01, it has the adsorption capacities of 159 and 21 mg/g towards toluene and methanol, respectively. At P/P₀ of 0.05, the capacities are 585 and 167 mg/g for toluene and methanol, respectively. With the further increase of P/P₀ to 0.1, the values reach 866 and 366 mg/g for toluene and methanol, respectively. These data suggest the highly responsive capture of the VOCs at the low P/P₀ range. Beyond this range (i.e., P/P₀>0.1), the toluene adsorption capacity (951 mg/g) is almost saturated at P/P₀ of 0.27, with marginal increases afterwards. While for methanol, the adsorption capacity still shows continuous increases though at reduced rates with the further increase of P/P₀.

The adsorption capacities of A-CNS21 towards toluene and methanol vapors at low P/P₀ (<0.1) are improved compared to various types of high-performance sorbents featured with higher maximum adsorption capacities. For example, though showing strikingly high maximum adsorption capacities, the hollow carbon nanospheres developed by Wu et al. show the adsorption capacities of ca. 800 and 240 mg/g for toluene and methanol, respectively, at P/P₀ of 0.1,₆ᵢ which are lower than the corresponding values (866 and 366 mg/g for toluene and methanol, respectively) of A-CNS21. For another instance, a mesoporous aromatic framework synthesized by Liu et al. showed a toluene adsorption capacity of ca. 800 mg/g at P/P₀ of 0.1 though having an excellent maximum adsorption capacity of 1,355 mg/g toward the saturated toluene vapor.₂₀ Compared to a well-known MOF, HKUST-1 with a remarkable toluene adsorption capacity of ca. 608 mg/g at low P/P₀ of 0.06,₂₁ the adsorption capacity of A-CNS21 at the same condition (697 mg/g) is also higher, along with a higher maximum capacity (967 vs. 620 mg/g). Without being bound by theory, the adsorption performance properties of A-CNS21 result from its textural properties, including the high surface area and the presence of micropores.

Compared to A-CNS21, AC-PDEB has much lower maximum adsorption capacities for both toluene and methanol (631 and 572 mg/g, respectively), which likely result from its significantly lower total surface area.

### CO₂ and H₂ Adsorption Performances

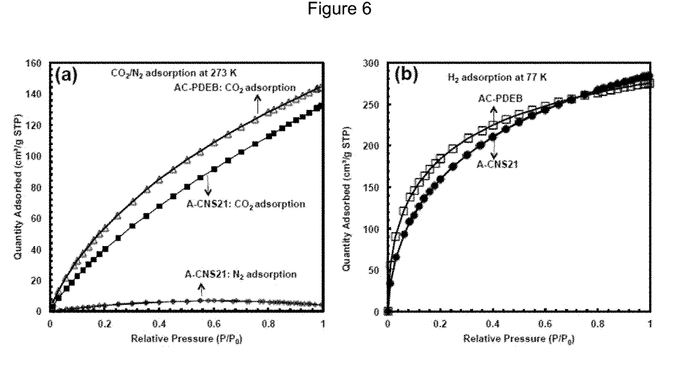

A-CNS21 has also been evaluated for its performances as the sorbent for the adsorption of CO₂ at 0° C. and H₂ at 77 K. FIG. 6 shows its adsorption isotherm within the pressure range of 0-1 bar at the respective temperatures, along with those of AC-PDEB for comparison. For both CO₂ and H₂, the desorption isotherms have been found to overlap well with the corresponding adsorption isotherms with the absence of hysteresis, confirming the reversible adsorption and desorption. The adsorption capacity data at 1 bar are summarized in Table 2. At 0° C. and 1 bar, A-CNS21 has a CO2 adsorption capacity of 26 wt % or 5.8 mmol/g and AC-PDEB has a slightly higher capacity of 28 wt % or 6.4 mmol/g. In CO₂ capture from flue gas, the selectivity of the sorbents towards CO₂ relative to other species such as N₂ is also critically important besides the adsorption capacity. The N₂ adsorption isotherm of A-CNS21 is also included in FIG. 6(a), which shows significantly reduced adsorption across the whole relative pressure range. The CO₂/N₂ Henry selectivity of A-CNS21 is determined to be 10.8, which is high for pure carbon based sorbents.₁₃

The adsorption capacities achieved herein with both A-CNS21 and AC-PDEB are high relative to those achieved with many other porous carbons. Compared to A-CNS21, the slightly higher capacity found with AC-PDEB should result from its slightly higher volume/surface area of micropores less than 0.8 nm (0.35 m3/g and 903 m2/g vs. 0.27 cm₃/g and 741 m₂/g).

A-CNS21 has a H₂ adsorption capacity of 2.5 wt % at 1 bar and 77 K, with a very similar capacity value of 2.4 wt % found for AC-PDEB. For nanoporous carbons, the H₂ adsorption capacity shows the predominant dependence on small micropores with sizes below 1.0 nm._{4a,b} Herein, the two samples have the similar volume and surface area of micropores less than 1.0 nm, with the values of A-CNS21 being slightly hgiher (0.51 cm₃/g and 1205 m₂/g for A-CNS21; 0.41 cm₃/g and 1035 m₂/g for AC-PDEB).

While the present disclosure has been described with reference to what are presently considered to be the preferred examples, it is to be understood that the application is not limited to the examples described herein. To the contrary, the present disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

TABLE 1
Textural properties of the polymer/carbon
samples determined by N₂ sorption at 77K.

| | Surface Area [symbol] | | | Pore Volume [symbol] | | | Average Pore | |
|---|---|---|---|---|---|---|---|---|
| | (m [symbol] /g) | | | (cm [symbol] /g) | | | Size [symbol] ( [symbol] ) | |
| Sample | S [symbol] | S [symbol] | S [symbol] | V [symbol] | V [symbol] | V [symbol] | d [symbol] | d [symbol] |
| PNS21 | 199 | 0 | 199 | 1.80 | 0 | 1.80 | 443 | |
| CNS21 | 580 | 323 | 256 | 1.52 | 0.17 | 1.35 | 416 | 7.3 |
| CNS11 | 493 | 165 | 327 | 1.04 | 0.09 | 0.95 | 261 | 8.3 |
| CNS38 | 407 | 249 | 158 | 1.13 | 0.13 | 1.00 | 407 | 8.0 |
| A-CNS21 | 2360 | 882 | 1477 | 1.98 | 0.46 | 1.52 | 268 | 9.1 |
| AC-PDEB | 1308 | 1081 | 228 | 0.73 | 0.57 | 0.16 | | 8.0 |

^{a}BET surface area (S_{BET}), as well as surface area of micropores (S [symbol] ) and mesopores/macropores (S [symbol] ) determined with t-plot method.
^{b}Total pore volume (V [symbol] ) as well as micropore volume (V [symbol] ) and mesopore/macropore volume (V [symbol] ) determined with t-plot method.
^{c}Average micropore size (d [symbol] ) and mesopore/macropore size (d [symbol] ) determined with NLDFT model. [symbol]
indicates data missing or illegible when filed

TABLE 2

| | Methanol adsorption | | | | Toluene adsorption | | | | | |
|---|---|---|---|---|---|---|---|---|---|---|
| | capacity (in mg/g) | | | | capacity (in mg/g) at | | | | CO₂ | H₂ |
| | at different P/P₀^{a} | | | | different P/P₀^{a} | | | | adsorption | adsorption |
| | P/P₀ [symbol] | P/P₀ [symbol] | P/P₀ [symbol] | P/P₀ [symbol] | P/P₀ [symbol] | P/P₀ [symbol] | P/P₀ [symbol] | P/P₀ [symbol] | capacity^{b} | capacity^{b} |
| Sample | 0.01 | 0.05 | 0.1 | 0.99 | 0.01 | 0.05 | 0.1 | 0.99 | (wt %) | (wt %) |
| A-CNS21 | 21 | 167 | 366 | 937 | 159 | 585 | 866 | 967 | 26 | 2.5 |
| AC-PDEB | 46 | 250 | 380 | 572 | 38 | 163 | 366 | 631 | 28 | 2.4 |

^{a}Methanol and toluene adsorption capacity measured at 25° C.
^{b}CO₂ sorption capacity measured at 0° C. and 1 bar.
^{c}H₂ sorption capacity measured at 77K and 1 bar. [symbol]
indicates data missing or illegible when filed

1. A process for preparing polymer nanospheres, the process comprising:
a) forming an aqueous emulsion or dispersion with water and at least one compound having two or more alkyne moieties; and
b) polymerizing the compound having two or more alkyne moieties in the emulsion or dispersion in the presence of a transition metal catalyst to form polymer nanospheres.

2. The process of claim 1, wherein the compound having two or more alkyne moieties is a (C₀-C₂₀)-alkyl, (C₆-C₂₀)-aryl or (C₅-C₂₀)-heteroaryl compound.

3. The process of claim 1, wherein the compound having two or more alkyne moieties is a (C₀-C₂₀)-alkyl, (C₆-C₂₀)-aryl or (C₅-C₂₀)-heteroaryl compound, having two terminal alkyne moieties.

4. The process of claim 1, wherein the compound having two or more alkyne moieties has the structure
R-A-R
wherein,
A is optionally substituted (C₀-C₂₀)-alkyl, (C₆-C₂₀)-aryl or (C₅-C₂₀)-heteroaryl;
each R is, independently or simultaneously, a moiety comprising an alkyne moiety; and
wherein the optional substituents on A are one or more of halo, hydroxy, (C₁-C₆)-alkyl, (C₁-C₆)-alkoxy or (C₂-C₆)-alkenyl.

5. The process of claim 4, wherein the wherein the compound having two or more alkyne moieties has the structure
R-A-R
wherein,
A is optionally substituted (C₀-C₂₀)-alkyl, (C₆-C₂₀)-aryl or (C₅-C₂₀)-heteroaryl;
each R is, independently or simultaneously, an alkyne moiety of the formula —X—C≡C—H;
X is (C₀-C₂₀)-alkylene, in which 1-3 carbon atoms are optionally replaced with O or N; and
wherein the optional substituents on A are one or more of halo, hydroxy, (C₁-C₆)-alkyl, (C₁-C₆)-alkoxy or (C₂-C₆)-alkenyl.

6. The process of claim 5, wherein the compound having two or more alkyne moieties has the structure 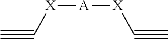
wherein
X is (C₀-C₂₀)-alkyl; and
A is optionally substituted (C₁-C₂₀)-alkyl, (C₆-C₂₀)-aryl or (C₅-C₂₀)-heteroaryl; and
wherein the optional substituents on Ring A are one or more of halo, hydroxy, (C₁-C₆)-alkyl, (C₁-C₆)-alkoxy or (C₂-C₆)-alkenyl.

7. The process of claim 6, wherein A is (C₀-C₁₀)-alkyl, (C₆-C₁₄)-aryl or (C₅-C₁₄)-heteroaryl.

8. The process of claim 7, wherein A is 1,7-octadiyne, 1,6-heptadiyne, or 1,5-hexadiyne.

9. The process of claim 7, wherein A is (C₆-C₁₀)-aryl or (C₅-C₁₀)-heteroaryl.

10. The process of claim 9, wherein A is substituted or unsubstituted phenyl or substituted or unsubstituted (C₅-C₆)-heteroaryl.

11. The process of claim 6, wherein X is (C₀-C₁₀)-alkyl, or (C₀-C₆)-alkyl, or (C₀-C₃)-alkyl.

12. The process of claim 1, wherein the compound having two or more alkyne moieties is

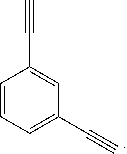

13. The process according to claim 1, wherein the process further comprises a mono-alkyne compound.

14. The process according to claim 13, wherein the mono-alkyne compound has the structure
R′-A′
wherein,
A′ is optionally substituted (C₀-C₂₀)-alkyl, (C₆-C₂₀)-aryl or (C₅-C₂₀)-heteroaryl;
R′ is a moiety comprising an alkyne moiety; and
wherein the optional substituents on A′ are one or more of halo, hydroxy, (C₁-C₆)-alkyl, (C₁-C₆)-alkoxy or (C₂-C₆)-alkenyl.

15. The process according to claim 14, wherein the compound is

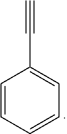

16. The process according to claim 1, wherein the process further comprises adding a surfactant in step (a).

17. The process according to claim 1, wherein the transition metal catalyst comprises a transition metal which is iron, copper, cobalt, titanium, nickel, platinum, ruthenium, rhodium or palladium.

18. The process of claim 1, further comprising step (c):
c) subjecting the polymer nanospheres to pyrolysis to form carbon nanospheres.

19. The process according to claim 18, wherein the polymer nanospheres are subjected to pyrolysis in the presence of an alkali metal hydroxide or alkaline earth metal hydroxide.

20. The process according to claim 18, wherein before step (c), the polymer nanospheres are mixed with water and hydrothermally treated.
